(19) United States
(12) Patent Application Publication
(10) Pub. No.: US 2019/0374960 A1
(43) Pub. Date: Dec. 12, 2019

(54) SPRINKLER MOTOR WITH BYPASS FILTER FOR GEAR-LUBRICATING WATER

(71) Applicant: MELNOR, INC., Winchester, VA (US)

(72) Inventor: Juergen Nies, Winchester, VA (US)

(73) Assignee: MELNOR, INC., Winchester, VA (US)

(21) Appl. No.: 16/432,032

(22) Filed: Jun. 5, 2019

Related U.S. Application Data
(60) Provisional application No. 62/681,336, filed on Jun. 6, 2018.

(51) Int. Cl. B05B 3/04; B05B 15/40

(52) U.S. Cl. CPC B05B 3/0409; B05B 15/40

(57) ABSTRACT

The preferred embodiments of the present invention provide a sprinkler motor (e.g., an engine that generates pivoting, rotation or other movement) for a spray hose in which the motor includes a gear mechanism that is lubricated by water sprayed via the spray hose. In the preferred embodiments, a direct water passageway is provided to gear chamber, along with a filter whereby water can be directed to the gears as a lubricant, while preventing debris from entering the gear mechanism.

The present application is a non-provisional and claims priority to U.S. provisional application Ser. No. 62/681,336, filed Jun. 6, 2018, entitled Sprinkler Motor with Bypass Filter for Gear-Lubricating Water, by J. Nies, the entire disclosure of which is incorporated herein by reference.

The present invention relates to a sprinkler motor for a sprinkler having a spray hose in which the motor includes a gear mechanism that is lubricated by water sprayed via the spray hose. The water is directed to the gear mechanism via a filter whereby water can be directed to the gears as a lubricant, while preventing debris from entering the gear mechanism.

### BACKGROUND

The present invention improves upon systems and methods as seen in, e.g., U.S. Pat. No. 5,052,621 (the '621 patent), the entire disclosure of which patent is incorporated herein by reference. Additionally, the detailed description of the '621 patent is inserted in the paragraphs below, and the figures of the '621 patent are incorporated herein as FIGS. 5-8:

“As is more particularly apparent from FIG. [5], a drive mechanism 1 according to [the '621 patent] is e.g. intended for the swivelling or pivoting operation of a sprinkler 2, which can be set up with the aid of a post 3, a tie rod, etc. Post 3 has in the represented embodiment two V-shaped, downwardly diverging, approximately U-shaped clips 4 extending in the longitudinal direction of the sprinkler and whose ends are laterally inserted in two end supports 5, 6 and with these form the bracket or the fixed or immovable component of the sprinkler 2 and between which is mounted a nozzle casing 7 as a movable component driven by the drive mechanism 1. The nozzle casing 7 has on its top surface at least one longitudinal row of differently oriented spray nozzles 8 from which, in substantially one plane, passes a type of water curtain, which can be inclined to the left and/or right, considered in the longitudinal direction, by the swivelling movement and in this way it is possible to sprinkle an area of adjustable size, e.g. a lawn or flowerbed.”

“The approximately cylindrical casing, which is downwardly widened in the vicinity of the drive mechanism 1, has on the front end remote from the drive mechanism 1a journal 9 engaging in a bearing opening of the associated support 6. The other end of the nozzle casing 7 forming the nozzle support is mounted in the associated support 5 with a hollow shaft 10 projecting above said end. The nozzle casing 7 is appropriately constituted by two lateral plastic half-shells, which engage in groove and tongue manner and are interconnected in liquid-type manner by ultrasonic welding or the like.”

“The drive mechanism 1 has as its drive motor a fluid-operated motor in the form of a hydraulic motor 11 forming with a base 12 a closed component, which is substantially completely located within the nozzle casing 7 and only projects with a short rear end portion from the rear end of the nozzle casing or box 7 for gear connection with support 5. The horizontal central axis 13 of hydraulic motor 11 coincides with the rotation or swivel axis of nozzle casing 7, the hollow shaft 10 being fixed in the rear end of base 12 and rotatably mounted in the plastic support 5. Immediately behind and equixially to the hollow shaft 10 is provided in the associated end face of support 5 a connection for a water line in the form of a hose connection, preferably a plug coupling member of a fast coupling. By means of the hose connection 14 through hollow shaft 10 the interior of base 12 for the hydraulic motor 11 is supplied with pressure water and this then completely passes out again through the wate exit connection 15 on the front end of base 12. On the connecting piece-like water exit connection 15 located in central axis 13 is engaged one end of an angular line or pipe bend 16 in sealed manner and its other end is inserted from below in a nozzle line 17 located in casing 7. Nozzle line 17 extends in the longitudinal direction of nozzle casing 7 over all the spray nozzles 8, so that they are connected with the inner ends of their nozzle bores jointly and directly to the nozzle line 17, whose cross-sections are substantially or many times smaller than that of the nozzle casing 7. Base 12 of hydraulic motor 11 is inserted directly behind line 17 in centred manner in a receptacle 18 of casing 7 and is e.g. prevented from rotation by cams engaging in the rear end wall of nozzle casing 7. The receptacle 18 can be formed by several circumferentially distributed ribs or the like, which engage on the outer circumference of base 12.”

“In the rear end of the base 12 of the hydraulic motor 11 constructed as a geared motor is provided a multistage, namely five to ten stage and preferably eight stage reduction gear 19, whereof a first gear stage can be formed by the inlet-side drive connection of the gear and a further gear stage by the outlet-side drive connection. Gear 19 is located in a gear chamber 20 of base 12 sealed from the water distribution system between hollow shaft 10 and water exit connection 15, the length of chamber 20 being roughly half the size of the external diameter of base 12 in its vicinity.”

“For the alternating reversal of the pivoting direction of nozzle casing 7 is provided a reversing device 21, which has a reversing valve 22 operated by the pivoting movement between two control positions. This reversing valve 22 is positioned in a control chamber 23, which is located in the same longitudinal portion of base 12 as the gear chamber 20, but is connected to the water distribution system between hollow shaft 10 and the water exit connection 15 or directly to the associated end of hollow shaft 10.”

“The water flowing through the water distribution system drives a drive rotor 24 of the hydraulic motor, said rotor 24 having in a rotor chamber 26 a turbine wheel 25 exposed to at least one nozzle jet. Within the base 12, the said rotor chamber 26 is provided axially directly following the gear chamber 20 and reversing chamber 23. However, in the vicinity of rotor chamber 26, the base 12 has a smaller internal and/or external diameter compared with the area of gear chamber 20 and control chamber 23. Rotor chamber 26 is directly supplied with flowing water from the control chamber 23 and said water then passes out of rotor chamber 26 directly through the water exit connection 15. Base 12 essentially comprises two axially attached casing parts 27, 28 and an end cap 29, which are centered by inserting in one another and are interconnected in watertight manner by ultrasonic welding or the like. The rear casing part 27 forms the end or front collar passing through the rear end of the nozzle casing 7 and the gear chamber 20 and reversing chamber 23 over most of the axial extension thereof. With its rear, external diameter-reduced end, the front casing part 28 is inserted in centered manner in the front end of casing part 27, whose internal diameter is increased in complementary manner and forms at a limited distance upstream of the rear casing part 27 a partition 30 roughly at right angles to central axis 13 and constructed in one part therewith and which spatially separates the rotor chamber from control chamber 23 and sealingly separates it from the gear chamber 20. In the rear region the rear casing part 27 forms an endwall 31 constructed in one piece therewith and by means of which said end collar projects rearwards and carries the front end of hollow shaft 10.”

“The rear casing part 27 also forms a partition wall 32 constructed in one piece therewith and which is connected both to the end wall and to the inner circumference of the casing jacket of said casing part 27 on facing sides and after attachment of the front casing part 28 is also tightly connected to the associated side of partition 30. This approximately planar partition wall 32 parallel to an axial plane of the casing is transversely displaced with respect to gear 19 with respect to said axial plane roughly by its thickness, so that the gear chamber 20 has a smaller capacity than the control chamber 23. A sleeve-like water inlet connection 33 in one piece with endwall 31 projects from the latter into the casing over part of the height of partition wall 32. Connection 33 partly penetrates the partition wall 32 constructed in one piece therewith, but in the vicinity of its inner end face is circular segmentally open only towards the control chamber 23 and is closed to the gear chamber 20. The water inlet connection 33 has an internal thread, into which is screwed the hollow shaft 10 with the external thread provided on its front end in such a way that the end face is braced with respect to the closed part of the inner end of the water inlet connection 33.”

“The turbine wheel 25 of drive rotor 24 has a rotor shaft 34 inserted in the hub with a diameter of only approximately 2 to 3 mm, whose end projecting over the rear face of turbine wheel 25 traverses a bearing bush 35 and is sealed in the bearing opening of the latter with an annular seal 36. The bearing bush 35 forming a closed component with the drive rotor 35 and a rotor pinion 37 and whose external diameter is slightly larger than that of the rotor pinion 37, is so sealingly inserted from the side of rotor chamber 26 into an opening in partition 30, that part of the circumference of pinion 37 projects into the gear chamber 20 and there produces the driving connection of drive rotor 24 with gear 19. The end of rotor shaft 34 more remote from the turbine wheel 25 located on the side of bearing bush 35 further therefrom and rotor pinion 37 can be mounted in a bearing boss of partition 30 projecting into gear chamber 20 and which sealingly engages in a corresponding cutout of partition wall 32 and is consequently precisely oriented and additionally supported.”

“Roughly symmetrically on either side of an axial plane of means 24 or base 12 roughly at right angles to partition wall 32, gear 19 has a cylindrical pin-like gear shaft 39 or 40, each of which is mounted with its front end in casing part 28 or in a blind bore of partition 30 and with its rear end in a blind bore of casing part 27. On each gear shaft 39, 40 is arranged in axially following manner a plurality of identical, stepped gear wheels 41, 42, 43. In each case the diameter-smaller gear wheel stage of one gear shaft drives the diameter-larger gear wheel stage of the other gear shaft. The larger diameter gear wheel stage of a first gear wheel 41 of gear shaft 39 is directly driven by the rotor pinion 37, whilst a smaller diameter gear wheel stage of the last gear wheel 43 of the same gear shaft 39 forms a driven pinion 44 of gear 19, which has a larger diameter than the remaining smaller gear wheel stages and projects through a window 47 over the inner circumference of an inner end collar 46, which is located concentrically within a collar 45 engaging in the rear endwall of nozzle casing 7.”

“In the vicinity of driven pinion 44 the two end collars 45, 46 are interconnected by an approximately shell-like pinion casing constructed in one piece therewith and which covers the driven pinion 44 over most of its circumference, namely up to the area projecting over window 47 and also on the rear end face and forms a bearing shoulder projecting into a bearing opening of driven pinion 44, in whose blind hole is mounted the rear end of gear shaft 39. The rear end of gear shaft 40 also extends over part of the axial extension of end collar 46, whose associated area is reinforced for receiving said rear end with a corresponding bearing stud.”

“The outer circumferences of the equal diameter, larger gear wheel stages of gear wheels 41, 42, 43 extend close to the associated side of the partition wall 32 and close to the inner circumference of the jacket of base 12 or gear chamber 20. As can be gathered from FIG. [7], in the vicinity of gear chamber 20, said jacket is provided on the inner circumference with a recess for receiving the gear wheels, so that it is thinner in this area than in the remaining areas.”

“For making a drive water jet act on the turbine wheel 25, there are two roughly tangentially, oppositely directed drive nozzles 48, 49 directed against the circumference of the said turbine wheel, whereof one determines the rotation direction in one sense and the other the rotation direction in the opposite sense. The nozzle openings 48, 49 are line connected to the control chamber 23 by means of drive nozzle ducts 50, 51 roughly axially parallel to base 12. The drive nozzle ducts 50, 51 project from partition 30 substantially freely into reversing chamber 23 and also from partition 30 forwards approximately to the end cap 29 into the rotor chamber 26.”

“The parts of the drive nozzle ducts 50, 51 projecting into control chamber 23 are formed by two cross-sectionally elongated, rectangular duct connections 52 located symmetrically on either side of the axial plane 38 and whose median planes roughly parallel to axial plane 38 are parallel to one another. The parts of drive nozzle ducts 50, 51 projecting into rotor chamber 26 are formed by separate duct portions 53 line connected to one of the duct connections 52 via a passage opening in partition 30, are connected to the diameter-reduced casing jacket of the front casing part 28 with their sides remote from turbine wheel 25 and in the direction of the latter become cross-sectionally narrower, in that their adjacent walls diverge cross-sectionally towards wheel 25, whilst their remote walls are located substantially parallel to one another in the planes of the associated walls of duct connections 52. The sides of duct portions 53 facing rotor shaft 34 are closed up to the rear end face of turbine wheel 25 and following on to this are open forming the nozzle openings of drive nozzles 48, 49. The front ends of the duct portions 53 remote from partition 30 are open prior to the fitting of end cap 29 and are closed by end closures 54 on mounting cap 29. Said end closures project in integral plate-like manner from the inside of the end wall of end cap 29, so that it is very easy to manufacture the casing from plastic.”

“The reversing device 21 or reversing valve 22 has a reversing member 56 for performing a control movement and which is pivotable about an axis at right angles to the casing axis and preferably located in axial plane 39 between two end positions over a relatively small angle and is shown in FIG. [8] in its central position. For pivotable mounting purposes the reversing member 55 has an approximately T-shaped rocker 56, whose T-top web is located within the control chamber 23 and whose T-base forms a control bolt 57 movably passing through end wall 31, but sealed with an annular seal 58 in such a way that the free end of bolt 57 projects rearwards over the end collars 45, 46. The control bolt 57 is located between these end collars 45, 46. On either side of the control bolt 57 the rocker 56 has on the associated side of the T-top web in each case one bearing edge 59 projecting against end wall 31 with which it is so supported in the vicinity of the inner end face of wall 31 on either side of seal 58, that the swivel axis is located in the plane of said inside and at right angles to the T-top web in the center of its length.”

“Rocker 56 is provided for operating a plate or strip-like valve body 61 substantially parallel thereto, which is formed by a leg of an angle profile and is located between the T-top web of rocker 56 and the free ends of drive nozzle ducts 50, 51 or duct connection 52. Valve body 61 is substantially only connected by engaging support with the rocker 56, accompanied by the interposing of a strip-like leaf spring 60, which only engages on the cam-like ends of the T-top web concavely curved corresponding to leaf spring 60 and consequently forms a subassembly with valve body 61 through centrally being traversed by a pin of said valve body 61 in a close and axially secured manner. The other leg of the valve body 61, which is slightly inwardly displaced with respect to the adjacent longitudinal edge of the valve body, engages in securing manner on the side of the T-top web of rocker 56 remote from the casing jacket.”

“With the valve body 61 or its slightly raised end portions remote from the rocker 56 are associated as valve seats 62 the closely facing end faces of the duct connection 52 faced by the valve body 61 in an axial area of base 12, which roughly coincides with the inner end face of the water inlet connection 33. In each swivel end position of rocker 56 one of the two valve seats 62 is closed and the other open. Valve body 61 is moved out of the central position according to FIG. [8] initially via the central connection with leaf spring 60 and then via one of the facing cams and can be pressed by the associated cam of rocker 56 against the valve seats 62. The valve body 61 is secured against lateral movement towards valve seats 62 by a counterholder 63 positioned between the valve seats 62 and which is formed by a web freely projecting from partition 30 in much the same way as duct connection 52 and faces a central projection of body 61. The valve body 61 is secured against longitudinal displacements by at least one locking device 64 facing casing 12, which is appropriately formed by an axial web on the inside of the casing jacket and/or on the outer circumference of the connecting piece forming the water inlet connection 33 and engages in a corresponding groove in the center of the associated longitudinal edge of valve body 61 with an adequate transverse clearance. The webs forming the locking device 64 also engage in corresponding grooves of the T-top web of rocker 56 with an even larger transverse clearance. Once the rubber elastic valve body 61 has been swung into a working position, then it is held therein by the hydraulic pressure until it is transferred to the other valve position by means of rocker 56.”

“A blade rim 65 formed by an external circumferential tooth system is rotatably mounted on hollow shaft 10 within end collar 46 and meshes with the smaller diameter driven pinion 44 and is axially displaceable with respect thereto. Up to a predetermined torque, the blade rim 65 is secured in non-rotary or positive manner with respect to support 5, which produces the driving connection between the hydraulic motor 11 or nozzle casing 7 and post 3.”

“For adjusting the swivel angle and range, the reversing device 21 has two ring-like adjusting members 66, 67 rotatable about central axis 13 and connected directly to the rear end of base 12, whereof one surrounds with a flange the rear end of base 12 or end collar 45, whilst the other, identically constructed adjusting member 66 projects rearwards in the opposite direction with its flange. The adjusting parts 66, 67 are mounted with two directly interlinked hubs 68, 69 on a bearing sleeve 70 of support 5 projecting freely towards hydraulic motor 11 and which spacedly surrounds the hollow shaft 10 and is provided in the vicinity of hubs 68, 69 with a relatively easily overcomable locking corrugation system for the engagement of corrugation segments of hubs 68, 69, so that the adjusting parts 66, 67 can only be rotated with a certain amount of difficulty and are securely held in the in each case set position.”

“Each adjusting part 66, 67 has a gripping attachment 71, 72 projecting in link plate-like manner over the outer circumference of its flange and located at the end of an outer flange segment of the associated adjusting part 66, 67 in such a way that its flange segments and the grip attachments 71, 72, when the adjusting parts 66, 67 are engaged, are located in a common plane and the flange segment of one grip part engages over the outer circumference of that of the other grip part.”

“In the annular disk-like areas of adjusting parts 66, 67 connecting the flanges and hubs 68, 69 are provided segmental slots 73, 74 for the engagement or passage of the control bolt 57, whose ends form driving stops for bolt 57. By reciprocal rotation of the adjusting parts 66, 67 the reciprocal spacing of the driving stops can be varied and by a joint rotation of parts 66, 67 their position can be varied with respect to an axial or reference plane.”

“In order that the last-mentioned adjusting possibility is limited to a predetermined adjustment range is provided a stop 75 of support 5 adjacent to the outside of bearing sleeve 70 and projecting in the same direction of the latter and which engages in corresponding slots of the annular disk-like areas of adjusting parts 66, 67 roughly diametrically facing slots 73, 74. In order that the rocker 56 or its control bolt 57 cannot be overloaded after reaching its end position, a protective bolt 76 is provided in freely rearwardly projecting manner on base 12 and with it are associated in the annular disk-like areas of adjusting parts 66, 67 stop faces, which are circumferentially displaced with respect to the driving faces of slots 73, 74 and can be formed by stepped end faces of said slots 73, 74. Protective bolt 76 is located on the side of control bolt 57 remote from casing axis 13 and between the end collars 45, 46 projects freely rearwards from end wall 31 by roughly the same distance as control bolt 57, so that prior to the fitting of the hydraulic motor 11 in support 5, it also forms a shield for the control bolt 57.”

“The operation of the reversing device can also be gathered from German patent 19 12 315, to which reference should be made for further details and effects.”

“The driven shaft of hydraulic motor 11 formed by the driven pinion 44 is drive-connected to the post 3, accompanied by the interposing of a safety clutch 77 located within support 5 and which acts between the blade rim 65 and the bearing sleeve 70. For this purpose the blade rim 65 is located at the end of a cup-shaped intermediate sleeve 78, which is mounted with a predetermined radial clearance within the bearing sleeve 70 and on the hollow shaft 10 in that its rear end forming the bottom of the cup is directly guided on the circumference of shaft 10, whilst its front end having the blade rim 65 is mounted on shaft 10, accompanied by the interposing of a guide sleeve 83 inserted therein. The rear end of intermediate sleeve 78 forms a coupling member 79 of safety clutch 77, whilst the other coupling member 80 is formed by an internal, collar of bearing sleeve 70 traversed by hollow shaft 10 and located between the sleeve ends, whose end remote from the rim 65 serves to support an end or shaft collar 84 of shaft 10, accompanied by the interposing of at least one seal 85 or an axial slip ring.”

“The rear end face of coupling member 79 and the front end face of coupling member 80 have complementary end teeth 81 passing over the circumference and the individual teeth have on either side lateral flanks inclined in such a way that they become narrower towards their head faces. Between the coupling member 79 and guide sleeve 83 is provided a pretensioned coupling spring 82 constructed as a helical compression spring and located within the intermediate sleeve 78 and around the hollow shaft 10. It forces the coupling member 79 of the intermediate sleeve 78 axially displaceably positioned on guide sleeve 83 into engagement with coupling member 80. If casing 12 and support 5 are loaded against one another by an excessive torque, then the teeth of coupling members 79, 80 jump over one another. The coupling member 79 is axially displaced under the flank pressure of the teeth counter to the tension of coupling spring 82 and through a corresponding fine tooth pitch, it is ensured that the coupling member 79 returns in virtually any rotary position to its rotation-locked engagement with coupling member 80.”

“Between reversing chamber 23 and rotor chamber 26 is provided a bypass water distribution means 86 avoiding the nozzle ducts 50, 51 and which limits to a constant amount the water quantity used for driving the hydraulic motor 11 substantially independently of the water quantity supplied through the water inlet connection 33, so as to obtain an approximately constant motor speed. The excess water quantity flows through passage openings 87 in partition 30 outside the outer circumference of turbine wheel 25 directly into the rotor chamber or against the casing jacket, the remote lateral faces of the duct portions 53 and a platform-like protuberance of partition 30 into rotor chamber 26, from where it is passed with the water for driving the turbine wheel 25 passing out through in each case one of the drive nozzles 48, 49 through the water outlet connection 15 to the nozzles 8 of nozzle casing 7.”

“Considered parallel to the axial plane 38 according to FIG. [8], the passage openings 87 are on either side laterally outside the duct portions 53 and, at right angles thereto or to the axial plane 38 according to FIG. [7], between the duct portion 53 and the rotor shaft 34 or the platform-like protuberance mounting the same and securing the associated ends of the gear shafts 39, 40 close to the inner circumference of rotor chamber 26. Each opening 87 has an excess pressure valve 88, whose movable flap-like valve part formed by a valve body 89 admittedly operates independently of the other valve part, but is constructed in one piece therewith. The valve seat 90 of each excess pressure valve 88 located within the rotor 26 is formed by a protuberance of partition 30 rising shallowly to the casing jacket and surrounding the in each case associated opening 87 and on it the valve body 89 rests in flat manner under a predetermined spring tension. For producing this spring tension the two valve bodies 89 are formed by the widened ends of a flat spring strip 91 made from suitable metal, which in the vicinity of its central widened part between the valve bodies 89 is traversed by a bolt 92, e.g. a self-tapping screw and is tensioned therewith in the axial plane 38 for fixing against partition 30. On reaching a predetermined pressure gradient between control chamber 23 and rotor chamber 26 the valve bodies 89 rise from the valve seat 90, so that the bypass water distribution means 86 opens in pressure-dependent manner.”

“Apart from the end closures 54, on the inside of end wall of end cap 29 are provided curved, plate-like guide members 93 in integral manner, which surround the turbine wheel 25 over part of its circumference following on to the remote sides of the drive nozzles 48, 49 or the duct portions 53. The passage openings 87 are substantially located outside the outer circumference of these guide members 93. With its end remote from the associated drive nozzle 48 or 49, each guide member 93 is connected to the inner circumference of the jacket of rotor chamber 26 due to the eccentric mounting of the turbine wheel 25, so that this inner circumference forms an extension of the guide member and a very high efficiency is obtained, because the water passing out of the particular drive nozzle 48 or 49 can leave the turbine wheel 25 substantially only in the direction towards the water exit connection 15.”

“On the inside of end wall of end cap 29 are also provided integrally projecting orienting attachments 94, which pass over the duct portions 53 on remote sides, so that the end cap 29 can only be fitted to casing part 28 in the correct fitting position. Finally, on the inside of end wall of end cap 29 there is an integrally projecting axial bearing journal 95 located in the rotor axis and whose tapered end faces the end face of a hub of turbine wheel 25 with a limited clearance and consequently limits the axial clearance of drive rotor 24. Substantially all the components of the described drive mechanism can be made from plastic or plastic-like materials. Only the leaf spring 60, coupling springs 82, spring strips 91 and bolt 92, together with the rotor shaft 34 and gear shafts 39, 40 need be made from metal.”

“As shown in FIG. [5], the hydraulic motor 11 is so fitted in the nozzle casing 7, that the gear 19 or gear chamber 20 is located above the water distribution system or control chamber 23, which is horizontal at the bottom. This makes it even more difficult for water to penetrate the gear chamber and for any water which may have penetrated it is possible to provide an appropriate drain or the like.”

Although the '621 patent teaches away from allowing water to penetrate the gear chamber, as discussed below, the present invention proceeds contrary to the '621 patent and provides a mechanism to allow appreciable flow of water to enter the gear chamber for, e.g., advantageous gear lubrication purposes.

### Summary of the Preferred Embodiments

The preferred embodiments of the present invention overcome the above and/or other problems in the background art.

According to some preferred embodiments, a sprinkler motor for a water sprinkler is provided that includes: a motor housing; a water inlet into the motor housing for receiving flowing water from an external water source; a water outlet from the motor housing for discharging flowing water from the sprinkler motor; a water flow path extending through the sprinkler housing from the water inlet to the water outlet for passage of water through the motor housing; a gear chamber separated from the water flow path and which is in fluid communication with the water flow path via a window having a filter that filters dirt and/or debris; a plurality of gears located within the gear chamber; wherein water entering the water flow path passes through the filter into the gear chamber such as to lubricate the gears while dirt and/or debris is inhibited from entry due to the filter.

According to some further embodiments, the sprinkler motor for a water sprinkler further includes that the water filter has openings sized to allow water to freely pass therethrough while inhibiting direct and debris.

According to some further embodiments, the sprinkler motor for a water sprinkler further includes that the plurality of gears are plastic gears.

According to some further embodiments, the sprinkler motor for a water sprinkler further includes that the plurality of gears are self-lubricating gears.

According to some further embodiments, the sprinkler motor for a water sprinkler further includes that the water sprinkler is configured to sprinkle water on vegetation in a yard or garden.

According to some other preferred embodiments, a method of lubricating a sprinkler motor for a water sprinkler is provided that includes: a) providing a sprinkler motor for a water sprinkler including: a motor housing; a water inlet into the motor housing for receiving flowing water from an external water source; a water outlet from the motor housing for discharging flowing water from the sprinkler motor; a water flow path extending through the sprinkler housing from the water inlet to the water outlet for passage of water through the motor housing; a gear chamber separated from the water flow path and which is in fluid communication with the water flow path via a window having a filter that filters dirt and/or debris; a plurality of gears located within the gear chamber; wherein water entering the water flow path passes through the filter into the gear chamber such as to lubricate the gears while dirt and/or debris is inhibited from entry due to the filter; and b) causing water to flow through the sprinkler motor from a water supply source and to enter the gear chamber through the filter such as to lubricate the gears while inhibiting dirt and/or debris from entry.

According to some further embodiments, the method further includes providing the plurality of gears as plastic gears.

According to some further embodiments, the method further includes self-lubricating the gears with lubricants contained within the material of the gears.

According to some further embodiments, the method further includes using the sprinkler motor for sprinkling water on vegetation within a yard or garden.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the invention are described, by way of example, in reference to the accompanying drawings, in which:

FIG. 1 is a cross-sectional side view of a sprinkler motor according to some embodiments of the invention;

FIG. 2 is a perspective view of the filter shown in FIG. 1 independent from the sprinkler motor for reference;

FIG. 3 is a cross-sectional side view of a sprinkler motor according to some other embodiments of the invention;

FIG. 4 is a cross-sectional side view of the sprinkler motor shown in FIG. 3 from a direction from the right side of FIG. 3; and

FIGS. 5-8 are background drawings from the above-noted U.S. Pat. No. 5,052,621 for reference.

### THE PREFERRED EMBODIMENTS

While the present invention may be embodied in many different forms, the illustrative embodiments are described herein with the understanding that the present disclosure is to be considered as providing examples of the principles of the invention and that such examples are not intended to limit the invention to preferred embodiments described herein and/or illustrated herein.

The preferred embodiments of the present invention provide a sprinkler motor (e.g., an engine that generates pivoting, rotation or other movement) for a spray hose in which the motor includes a gear mechanism that is lubricated by water sprayed via the spray hose. In the preferred embodiments, a direct water passageway is provided to gear chamber, along with a filter whereby water can be directed to the gears as a lubricant, while preventing debris from entering the gear mechanism.

As discussed above, in the device of the '621 patent, a partition wall 32 is provided that separates a gear chamber from a water distribution area. According to some embodiments of the invention, a filter element is included within such a partition wall 32. This filter is configured to keep damaging dirt and/or debris from entering the gear chamber while allowing lubricating water to pass through the filter and help inhibit the gears from wearing out prematurely.

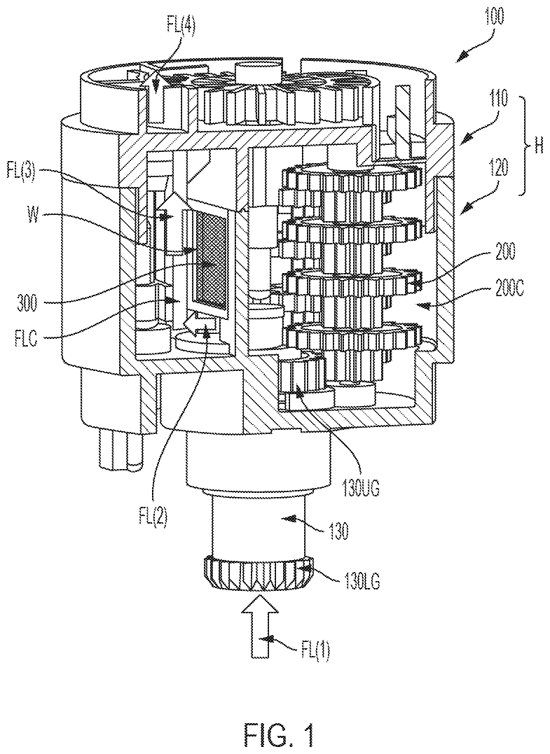

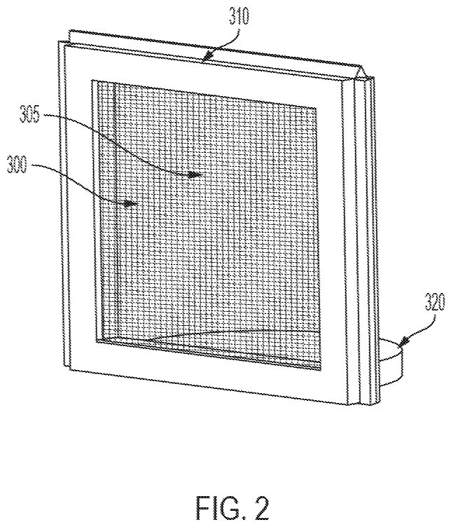

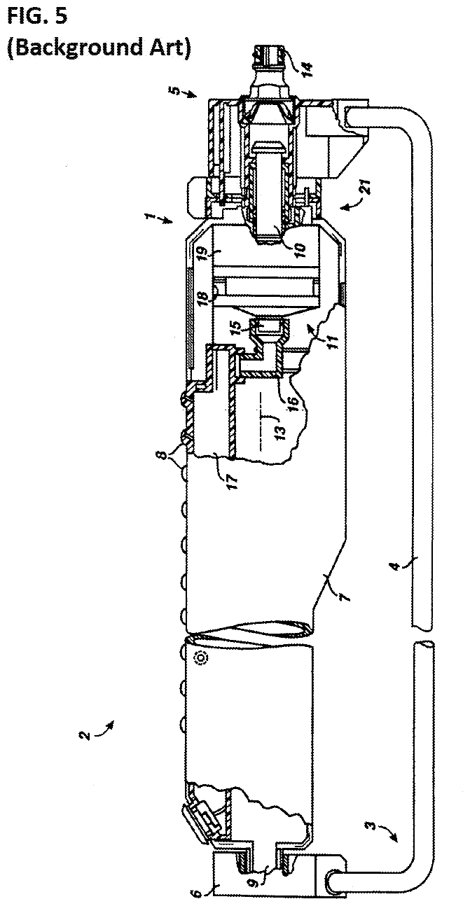

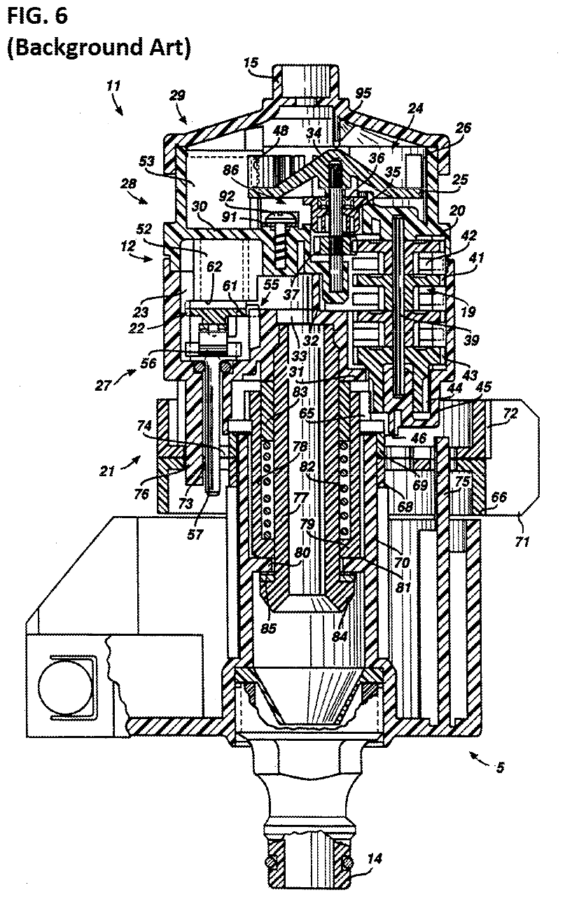

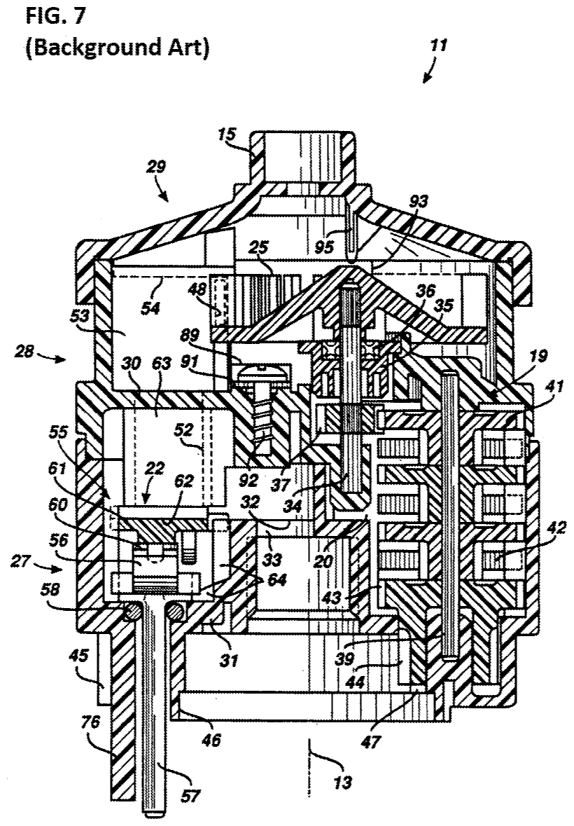

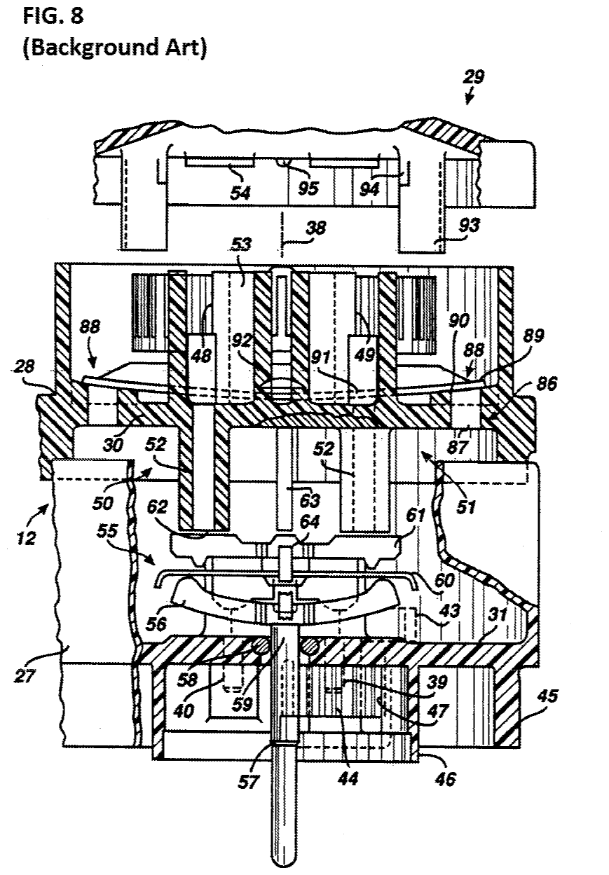

One illustrative embodiment of the present invention is shown in FIGS. 1-2. This embodiment can be implemented within a system similar to that shown in system shown in FIGS. 5-8. In particular, the device shown in FIGS. 1-2 can be employed to transmit water therethrough for spraying, while causing pivotal or rotational movement in a like manner to that described above with respect to FIGS. 5-8.

With reference to FIG. 1, in this illustrative embodiment, a sprinkler motor 100 is provided that includes a housing H having an upper portion 110 and a lower portion 120. As illustrated, the housing H includes a gear chamber 200C that houses gears 200. In the preferred embodiments, the gears 200 can operate in a similar manner to the reduction gears 19 of the background system shown in FIGS. 5-8. Although not illustrated, the gears 200 can be caused to rotate by means of a rotor (similar to the rotor 24 and related structure described in relation to FIGS. 5-8). As with the embodiment shown in FIGS. 5-8, the gears 200 can be employed to impart external rotation in order to achieve pivotal or rotational or other movement of a sprinkler system that the motor 100 is implemented within.

As shown in FIG. 1, in operation, water enters the sprinkler motor 100 via a receiving tube 130 and follows the flow path FL(1) shown in FIG. 1. The water then exits the receiving tube 130 and enters a flow chamber FLC within the housing H at a position proximate to a lower end of the housing H. The water entering the housing H is laterally deflected along the flow path FL(2) as shown in FIG. 1. Thereafter, the water follows a flow path FL(3) through the housing H and exits the housing H such as to follow the flow path FL(4) and then be discharged for sprinkling discharge from the sprinkler system.

As shown in FIG. 1, the flow chamber FLC is sealed such as to create a fluid flow path through the motor 100. In addition, the flow chamber FLC is separated from the gear chamber 200C. However, according to the preferred embodiments of the present invention, a window W is provided between the flow chamber FLC and the gear chamber 200C, which window W has a filter 300. The filter 300 is configured to allow water to pass through the window while inhibiting debris and/or dirt from passing there-through. In this manner, water that flows through the sprinkler motor housing H will enter the gear chamber 200C. At the same time, dirt and/or debris will be inhibited from entering the gear chamber 200C. As a result, the water entering the gear chamber 200C can provide lubrication of the gears 200 during operation.

Preferably, the window W and the filter 300 are configured with a sufficient surface area and porosity to allow water to freely pass through the filter 300 and enter the gear chamber 200C during use (e.g., when water is caused to pass through the flow chamber FLC for sprinkler operation). In addition, the window W and the filter 300 are also preferably configured with a sufficient surface area and porosity to allow water to drain from the gear chamber 200C after use (e.g., when water is no longer caused to pass through the flow chamber FLC for sprinkler operation).

In some preferred embodiments, the filter element is made of a mesh screen having crossing filaments (e.g., horizontal and vertical filaments), with openings through-holes between the filaments sized to allow water to pass there-through while inhibiting passage of dirt and debris. In some illustrative embodiments, the holes in the filter will have a maximum diameter of less than 1000 microns, while in some other embodiments, the holes in the filter will have a maximum diameter of less than 500 microns, while in some other embodiments, the holes in the filter will have a maximum diameter of less than 400 microns, while in some other embodiments, the holes in the filter will have a maximum diameter of less than 300 microns, while in some other embodiments, the holes in the filter will have a maximum diameter of less than 200 microns, while in some other embodiments, the holes in the filter will have a maximum diameter of less than 100 microns. In some preferred examples, the holes in the filter have diameters of about 150 microns.

In some preferred embodiments, the filter is substantially rectangular, and has minimum diameter of a few millimeters or larger. In some illustrative embodiments, the filter has a minimum diameter of over ½ centimeter. In some other illustrative embodiments, the filter has a minimum diameter of over 1 centimeter. In some other illustrative embodiments, the filter has a diameter of over about 2 centimeters. In the preferred embodiments, the filter has a surface area that is sufficient to allow water to readily pass into the gear chamber during operation (i.e., while water is directed through the device for spraying). In addition, in the preferred embodiments, the filter has a surface area that is sufficient to allow the water to readily drain from the gear chamber after operation (i.e., after water has been directed through the device for spraying). In particular, in some most preferred embodiments, the water can enter and/or exit the gear chamber via the filter. As a result, when water enters the gear chamber, the water will remain in the chamber until the water is drain out through the filter.

In some preferred embodiments, during operation, a sufficient amount of water will enter the gear chamber due to the flow of water to provide lubrication to the gears located within the gear chamber. Towards that end, during use, the gear chamber preferably fills with sufficient water to contact all of the gears within the gear chamber. In some embodiments, the gear chamber will substantially entirely fill with water during use such that all of the gears are submerged in water. In some embodiments, the gear chamber will fill about 75% or more with water during operation. In some embodiments, the gear chamber will fill about 50% or more with water during operation. In some embodiments, the gear chamber will fill about 25% or more with water during operation. In some preferred embodiments, the water within the gear chamber is circulated due to, e.g., rotation of the gears, whereby all or substantially all of the friction surfaces of the gears are lubricated by the water.

In some preferred embodiments, the gears 200 are plastic gears. In some embodiments, the gears are made with thermoplastic materials, such as, e.g., acetal or nylon, or thermoset materials. In some embodiments, the gears can be made with polyethylene, polyamides or other suitable plastic materials. In some embodiments, the gears are made with self-lubricating plastics (e.g., plastics having added internal lubricants such as, e.g., polytetrafluoroethylene or silicone). In some preferred embodiments, the plastic materials are resistant to absorption of moisture or water.

With reference to FIG. 2, in this illustrative embodiment, the filter 300 includes a frame 310 that supports a mesh screen 305 having filaments extending substantially perpendicular to one another (e.g. horizontally and vertically). In addition, in this illustrative example, the frame 310 includes a lateral wall portion 320. As shown in FIG. 1, the lateral wall portion is arranged to cause water that enters the sprinkler motor 100 through the tube 130 to be caused to turn laterally along the flow path FL(2) into the flow chamber FLC.

In some illustrative examples, the rotation imparted to the motor 100 by the water flow can be implemented using a rotor that is fixed within the upper portion 110 of the housing H. In such embodiments, the rotation imparted to the rotor would be, in turn, imparted to the gears 200 (e.g., similar to that of the '621 patent discussed above). As in the '621 patent, the rotation imparted to the gears 200 can be imparted to cause an external rotation that is used to impart a motion such as, e.g., pivoting or rotation of the sprinkler device. For example, in some embodiments, the rotation of the gears can impart motion to the tube 130 via an upper gear section 130UG shown in FIG. 1. In some embodiments, the tube 130 can, thus, be rotated to impart an external rotation for the sprinkler device which can be imparted externally to further sprinkler gears and/or mechanisms via the lower gear section 130LG. In some alternative embodiments, a rotor of the like could be implemented to directly cause rotation of the tube 130, which could in turn impart rotation to the gears 200, which could in turn impart rotation to sprinkler gears and/or mechanisms. In some preferred embodiments, where the tube 130 is rotated relative to the housing H, additional sealing mechanisms, such as, e.g., o-rings OR, can be employed between a receiving tube of the lower portion 120 of the housing H and the exterior of the tube 130 as shown in FIG. 1.

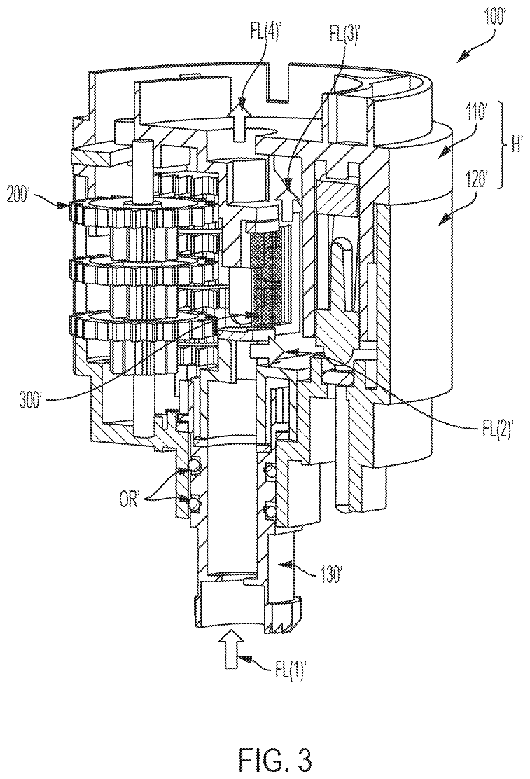

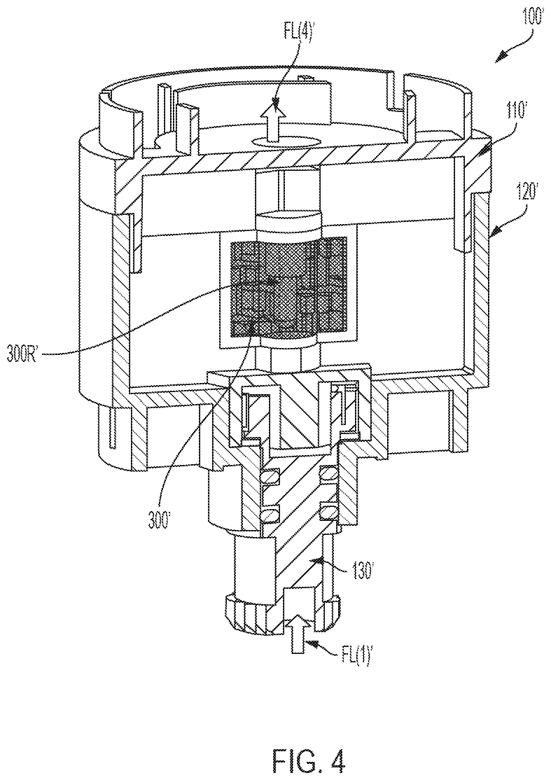

A second illustrative embodiment of the present invention is shown in FIGS. 3 and 4. The embodiment shown in FIGS. 3 and 4 is similar to that shown in FIGS. 1 and 2. In the embodiment shown in FIGS. 3 and 4, like parts are shown by like reference numbers, with the addition of a prime reference sign—i.e.,′. Towards this end, FIGS. 3 and 4, show an illustrative sprinkler motor 100′ which is similar to that shown in FIGS. 1 and 2.

As shown in, e.g., FIG. 4, in this second embodiment, the window W′ and filter 300′ are formed with a central arced or contoured region 300R′. However, the device of this second embodiment operates in a like manner to that of the first embodiment described above. As shown in FIGS. 3 and 4, according to the second illustrative embodiment, a sprinkler motor 100′ is provided that includes a housing H′ having an upper portion 110′ and a lower portion 120′. As illustrated, the housing H′ includes a gear chamber that houses gears 200′. In the preferred embodiments, the gears 200′ can operate in a similar manner to the reduction gears 19 of the background system shown in FIGS. 5-8. The gears 200′ can be caused to rotate by means of a rotor (similar to the rotor 24 and related structure described in relation to FIGS. 5-8). As with the embodiment shown in FIGS. 5-8, the gears 200′ can be employed to impart external rotation in order to achieve pivotal or rotational or other movement of a sprinkler system that the motor 100′ is implemented within.

As shown in FIG. 3, in operation, water enters the sprinkler motor 100′ via a receiving tube 130′ and follows the flow path FL(1)′ shown in FIG. 1. The water then exits the receiving tube 130′ and enters a flow chamber within the housing H′ at a position proximate to a lower end of the housing H′. The water entering the housing H′ is laterally deflected along the flow path FL(2)′ as shown in FIG. 3. Thereafter, the water follows a flow path FL(3)′ through the housing H′ and exits the housing H′ such as to follow the flow path FL(4)′ and then be discharged for sprinkling discharge from the sprinkler system.

As shown in FIG. 1, the flow chamber sealed such as to create a fluid flow path through the motor 100′. In addition, the flow chamber is separated from the gear chamber. However, according to the preferred embodiments of the present invention, a window is provided between the flow chamber and the gear chamber, which window has a filter 300′. The filter 300′ is configured to allow water to pass through the window while inhibiting debris and/or dirt from passing there-through. In this manner, water that flows through the sprinkler motor housing H′ will enter the gear chamber. At the same time, dirt and/or debris will be inhibited from entering the gear chamber. As a result, the water entering the gear chamber can provide lubrication of the gears 200′ during operation.

Preferably, the window and the filter 300′ are configured with a sufficient surface area and porosity to allow water to freely pass through the filter 300′ and enter the gear chamber during use (e.g., when water is caused to pass through the flow chamber for sprinkler operation). In addition, the window and the filter 300′ are also preferably configured with a sufficient surface area and porosity to allow water to drain from the gear chamber after use (e.g., when water is no longer caused to pass through the flow chamber for sprinkler operation).

Although FIGS. 1, 3 and 4 are depicted in cross-sectional format (i.e., to enable viewing of the interior of the respective sprinkler motors, it should be apparent that the construction of the sprinkler motor would be such as to create a fluid follow path, etc., as discussed above. Thus, e.g., in preferred embodiments, the respective sprinkler motors would be enclosed (i.e., without openings depicted by the cross-sectional cutouts in the figures), such as, e.g., to have a substantially tubular shape or substantially cylindrical shape housing H, H′ as shown.

### Broad Scope of the Invention

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure, the following abbreviated terminology may be employed: “e.g.” which means “for example.”

What is claimed is:

1. A sprinkler motor for a water sprinkler, comprising:
a motor housing;
a water inlet into said motor housing for receiving flowing water from an external water source;
a water outlet from the motor housing for discharging flowing water from the sprinkler motor;
a water flow path extending through the sprinkler housing from the water inlet to the water outlet for passage of water through the motor housing;
a gear chamber separated from the water flow path and which is in fluid communication with the water flow path via a window having a filter that filters dirt and/or debris;
a plurality of gears located within said gear chamber;
wherein water entering the water flow path passes through said filter into the gear chamber such as to lubricate the gears while dirt and/or debris is inhibited from entry due to the filter.

2. The sprinkler motor for a water sprinkler according to claim 1, wherein said water filter has openings sized to allow water to freely pass there-through while inhibiting direct and debris.

3. The sprinkler motor for a water sprinkler according to claim 1, wherein said plurality of gears are plastic gears.

4. The sprinkler motor for a water sprinkler according to claim 1, wherein said plurality of gears are self-lubricating gears.

5. The sprinkler motor for a water sprinkler according to claim 1, wherein said water sprinkler is configured to sprinkle water on vegetation in a yard or garden.

6. A method of lubricating a sprinkler motor for a water sprinkler, comprising:
a) providing a sprinkler motor for a water sprinkler, comprising:
a motor housing;
a water inlet into said motor housing for receiving flowing water from an external water source;
a water outlet from the motor housing for discharging flowing water from the sprinkler motor;
a water flow path extending through the sprinkler housing from the water inlet to the water outlet for passage of water through the motor housing;
a gear chamber separated from the water flow path and which is in fluid communication with the water flow path via a window having a filter that filters dirt and/or debris;
a plurality of gears located within said gear chamber;
wherein water entering the water flow path passes through said filter into the gear chamber such as to lubricate the gears while dirt and/or debris is inhibited from entry due to the filter; and
b) causing water to flow through the sprinkler motor from a water supply source and to enter the gear chamber through the filter such as to lubricate the gears while inhibiting dirt and/or debris from entry.

7. The method of claim 1, further including providing the plurality of gears as plastic gears.

8. The method of claim 1, further including self-lubricating the gears with lubricants contained within the material of the gears.

9. The sprinkler of claim 1, further including using the sprinkler motor for sprinkling water on vegetation within a yard or garden.
